(19) United States
(12) Patent Application Publication
(10) Pub. No.: US 2009/0064761 A1
(43) Pub. Date: Mar. 12, 2009

(54) Device for detecting a measured value

(76) Inventors: Andreas Derr, Wutoschingen (DE); Christoph Edelmann, Freiburg (DE); Wolfgang Eiche, Neuenweg (DE); Jens Amberg, Neustadt (DE)

Correspondence Address: MUIRHEAD AND SATURNELLI, LLC, 200 FRIBERG PARKWAY, SUITE 1001, WESTBOROUGH, MA, 01581, US

(21) Appl. No.: 11/900,206

(22) Filed: Sep. 10, 2007

(51) Int. Cl. G01N 19/10; G01D 21/00

(52) U.S. Cl. 73/29.02; 73/866.5

(57) ABSTRACT

A device for detecting a measured value includes a measuring transducer and a channel sensor, which is implemented as an essentially cylindrical tube having a first end and a second end and may be mounted in a wall when the measuring transducer is situated on the channel sensor. A detachable fastening device is included for fastening the measuring transducer to the channel sensor and may be disposed between the measuring transducer and the channel sensor. The channel sensor may be connected to the measuring transducer via a cable.

### TECHNICAL FIELD

This application relates to a device for detecting a measured value.

### BACKGROUND OF THE INVENTION

Devices for detecting a measured value, such as the temperature or the humidity, having a measuring transducer and a channel sensor are known, the channel sensor being implemented as an essentially cylindrical tube having a first end and a second end and being capable of being mounted in a wall with the measuring transducer situated on the channel sensor. It is essential that the channel sensor (and the fastening of the sensor in the wall) be able to carry the weight of the measuring transducer, which may be significantly larger than the weight of the channel sensor. Devices of this type are known in particular for measuring the humidity and temperature from the brochure of Testo AG “Feuchte-Messumformer [humidity measuring transducer] hygrotest 600/550”. The channel sensor is fixedly connected to the measuring transducer. If the measuring transducer is to be replaced, the channel sensor must also be replaced simultaneously. This is relatively expensive, particularly if the channel sensor passes through the wall in which it is sealingly held.

Furthermore, devices for detecting a measured value having a measuring transducer and a separate probe, with the probe being connected to the measuring transducer via a cable, are known from the same brochure. The measuring transducer must be fastened at a suitable point on a wall or a support via complex fastening devices.

Accordingly, it would be desirable to provide a device for detecting a measured value, which is easily mountable and flexibly usable. In particular, it would be desirable to provide for simple replacement of a measuring transducer.

### SUMMARY OF THE INVENTION

According to the system described herein, a detachable fastening device for fastening the measuring transducer to the channel sensor may be provided between the measuring transducer and the channel sensor, and the channel sensor may be connected to the measuring transducer via a cable. The connection via a cable ensures the data transmission, while the detachable fastening device between the channel sensor and the measuring transducer allows simple replacement of the measuring transducer even when the channel sensor is already mounted, without additionally having to remove the channel sensor from its position in a wall. An additional complex fastening device for the measuring transducer on the wall itself is thus dispensed with.

The fastening device may be implemented as a formfitting, form-complementary, or catch connection; connections of this type may be produced and detached again easily without great installation effort. In particular, it is not necessary to tighten screws to produce this connection, which significantly reduces the installation effort and cost.

In an embodiment of the system described herein, the fastening device may be formed by a first part and a second part, the first part being situated on the channel sensor and the second part being situated on the measuring transducer. The two parts are implemented in such a way that the second part is securable on the first part. Therefore, if the channel sensor is mounted at an intended location in the wall, the measuring transducer may be secured on the first part of the channel sensor easily via its second part, without having to mount the measuring transducer complexly on the wall in proximity to the channel sensor.

The second part may have a U-shaped design having an interior peripheral undercut, so that this U-shaped part, which may be open on the bottom, may be secured on the channel sensor drawn over a correspondingly shaped first part thereon, so that in this way a secure and stable connection is ensured. The U-shaped second part may widen toward its open end, so that an insertion aid for securing the second part on the first part is formed.

The fastening device or the second part of the fastening device may be situated on a rear wall of the measuring transducer, so that if the channel sensor is situated in a wall and the measuring transducer is situated over the fastening device on the channel sensor; operating keys, displays, or the like situated on the front side of the measuring transducer are thus easily accessible.

To make the device as compact as possible, the fastening device or the first part of the fastening device may be situated on the first end of the channel sensor.

The cable may be situated on the first end of the channel sensor. In particular, the longitudinal axis of the cable may run in the direction of the axis of the channel sensor at the fastening point of the channel sensor.

However, to reduce the risk of breaking of the cable, the cable may be guided at an angle of approximately 90° by the fastening device situated on the first end of the channel sensor or the first part of the fastening device situated at the first end of the channel sensor, so that the measuring transducer may be situated on the front face in front of the first end of the channel sensor and the cable may be guided parallel to the wall of the measuring transducer due to the angling.

According further to the system described herein, the measuring transducer may be a humidity measuring transducer and/or a temperature measuring transducer. Furthermore, the channel sensor may be a humidity channel sensor and/or a temperature channel sensor.

In an embodiment of the system described herein, a digital interface may be situated between the measuring transducer and the channel sensor.

### BRIEF DESCRIPTION OF THE DRAWINGS

Embodiments of the system described herein are described in greater detail on the basis of the following figures of the drawings.

FIG. 1 shows a device for detecting a measured value having a measuring transducer and a channel sensor according to an embodiment of the system described herein.

FIG. 2 shows the device according to FIG. 1 having a measuring transducer situated on the channel sensor.

FIG. 3 shows an axial section through the channel sensor according to FIG. 1.

### DETAILED DESCRIPTION OF VARIOUS EMBODIMENTS

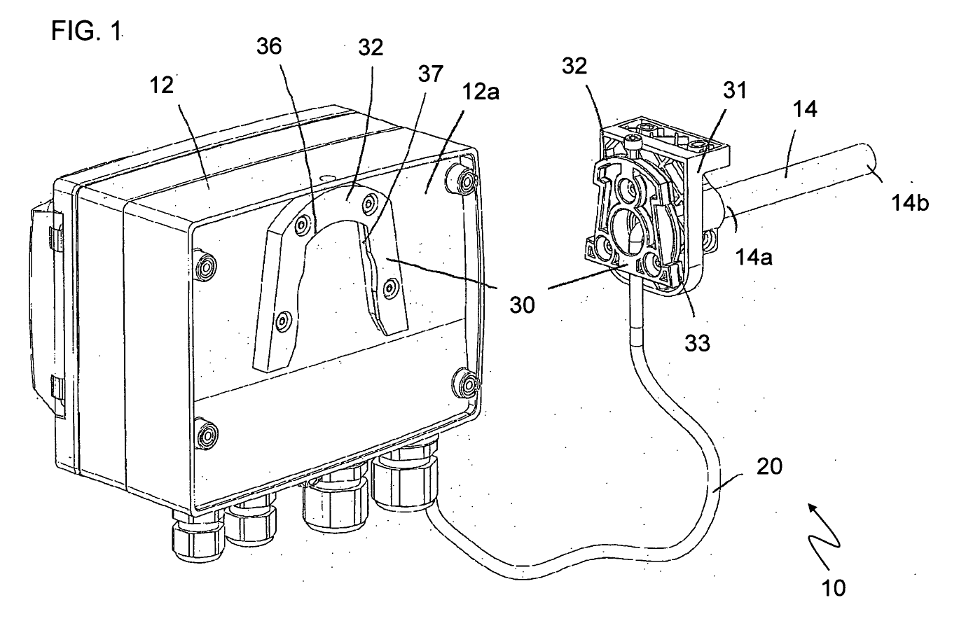

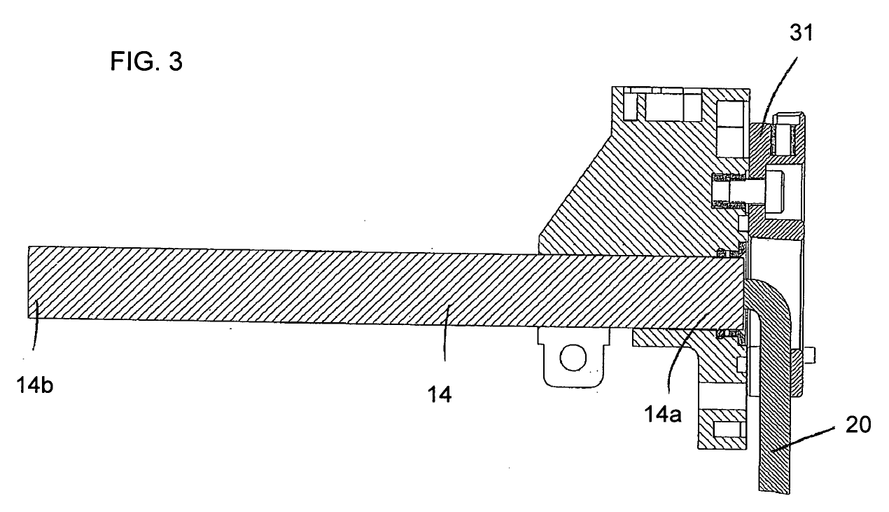

Various views of a device 10 which has a measuring transducer 12 and a channel sensor 14 for detecting a measured value, in particular for detecting the humidity or the temperature, are shown in FIGS. 1 through 3. The illustrated device 10 may, for example, be used in air-conditioning units, air dehumidifier systems, food production plants, or warehouses, in which humidity and temperature must be measured stably and regulated if needed.

Similar components are identified by the same reference numerals in the various figures.

In the channel sensor 14, which may be implemented as a cylindrical tube having a first end 14a and a second end 14b, an appropriate probe for detecting the desired measured value is situated in the area of the second end 14b. The probe may be electrically connected inside the tube to a cable 20 situated at the first end 14a. The cylindrical tube of the channel sensor 14 typically passes through a wall, so that the second end 14b projects into a space on one side of the wall in which the corresponding measured value is to be detected, while the first end 14a is on the other side of the wall, from where the detected measured value is relayed to the measuring transducer 12. The channel sensor 14 is situated in the wall in such a way that attaching an additional weight to the first end 14a, in particular in the form of the measuring transducer 12, has little or no effect on the fastening of the channel sensor 14 in the wall.

The measuring transducer 12 is situated on the channel sensor 14 via a fastening device 30. The fastening device 30 has a first part 31 and a second part 35, the first part 31 being situated on the first end 14a of the channel sensor 14 and the second part 35 being situated on a rear wall 12a of the measuring transducer 12.

The second part 35 may be implemented as a U-shaped part 36 having an undercut 37 on the inner side. The second part 35 is situated on the rear wall 12a in such a way that the opening of the U-shaped part 36 points downward. The first part 31 has a support contour 32, which may be form-complementary to the U-shaped part 36 and thus essentially have a U-shaped support contour 32 with an undercut 33 situated on the outer side.

The second part 33 may be engaged with the first part 31 in such a way that initially the measuring transducer 12 having the second part 35 is held vertically above the channel sensor 14 and the first part 31, and when the measuring transducer 12 is lowered in the vertical direction, the undercut 37 of the second part 35 is engaged with the undercut 33 of the first part 31. The measuring transducer 12 is thus secured via the second part 35 on the first part 31, which is situated on the channel sensor 14.

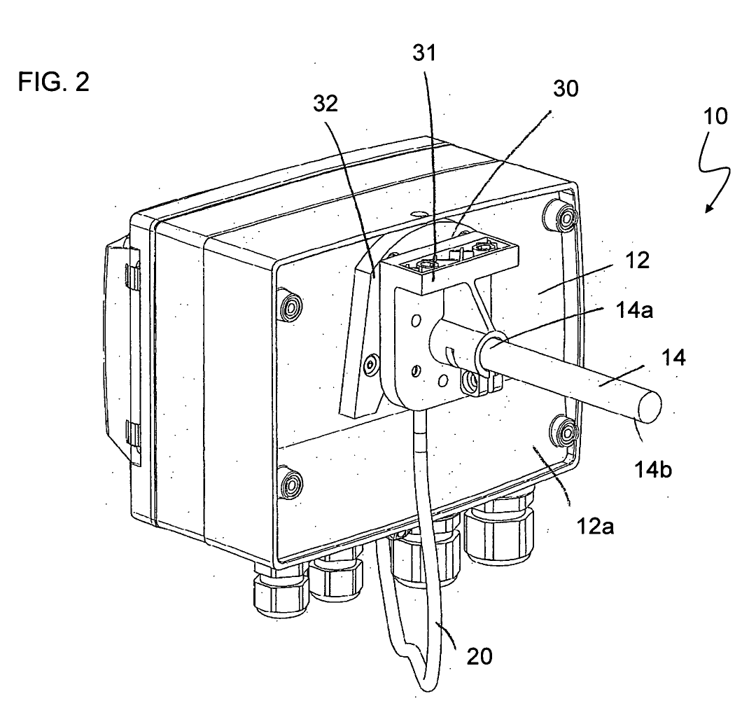

The U-shaped part 36 of the second part 35 widens toward its open end to aid in insertion thereof. As shown in FIG. 2, the measuring transducer 12 may be situated on the channel sensor 14, a detachable, but stable connection being produced between the measuring transducer 12 and the channel sensor 14 via the fastening device 30. The cable 20 may be connected to the measuring transducer 12 for the electrical connection of the channel sensor 14.

The second part 35 of fastening device 30 is situated on the rear wall 12a of the measuring transducer 12, so that operating keys, displays, switches, or the like situated on the side of the measuring transducer 12 diametrically opposite to the rear wall 12a are easily accessible to the user when the channel sensor 14 is mounted in a wall and the measuring transducer 12 is situated on the channel sensor 14.

The cable 20 is led out from the channel sensor 14 through the first end 14a of the channel sensor 14 in such a way that initially the longitudinal axis of the cable 20 runs essentially parallel to the longitudinal axis of the channel sensor 14. This reduces the likelihood of suffering a cable break while allowing the cable 20 to be situated as compactly as possible and in a space-saving way on the device 10. The cable 20 is guided in the first part 31 of the fastening device 30 in such a way, however, that the cable 20 is angled by 90°. The angling has a radius large enough to reduce the risk of a cable break of the cable 20 at this point. If the measuring transducer 12 is situated over the second part 35 on the first part 31 of the channel sensor 14, the cable 20 thus runs parallel to the rear wall 12a of the measuring transducer 12.

The cable 20 may be connected to the measuring transducer 12 via a digital interface so that at this point, if measuring transducer 12 has to be replaced, the connection between the measuring transducer 12 and the cable 20 may be easily detached. The connection via the fastening device 30 between the measuring transducer 12 and the channel sensor 14 may also be detached easily, so that if the measuring transducer 12 has to be replaced, the channel sensor may remain in its position in the wall, which significantly simplifies the replacement of the measuring transducer 12.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A device for detecting a measured value, comprising:
a measuring transducer;
a channel sensor, wherein the channel sensor is a substantially cylindrical tube having a first end and a second end, and wherein the channel sensor is mountable in a wall when the measuring transducer is situated on the channel sensor; and
a detachable fastening device disposed between the measuring transducer and the channel sensor for fastening the measuring transducer to the channel sensor, and wherein the channel sensor is connected to the measuring transducer via a cable.

2. The device as recited in claim 1, wherein the fastening device is at least one of: a formfitting connection, a form-complementary connection and a catch connection.

3. The device as recited in claim 1, wherein the fastening device is formed by a first part and a second part, the first part being situated on the channel sensor and the second part being situated on the measuring transducer, and wherein the second part is securable on the first part.

4. The device as recited in claim 3, wherein the second part has a U-shaped design having an internal peripheral undercut, the U-shaped second part widening toward an open end of the U-shaped part.

5. The device as recited in claim 1, wherein at least a part of the fastening device is situated on a rear wall of the measuring transducer.

6. The device as recited in claim 1, wherein at least a part of the fastening device is situated at the first end of the channel sensor.

7. The device as recited in claim 1, wherein the cable is situated at the first end of the channel sensor.

8. The device as recited in claim 1, wherein the cable is guided at an angle of approximately 90° through at least a part of the fastening device situated on the first end of the channel sensor.

9. The device as recited in claim 1, wherein the measuring transducer is at least one of: a humidity measuring transducer and a temperature measuring transducer.

10. The device as recited in claim 1, wherein the channel sensor is at least one of: a humidity channel sensor and a temperature channel sensor.

11. The device as recited in claim 1, further comprising:
a digital interface situated between the measuring transducer and the channel sensor.

12. A device for detecting a measured value, comprising:
a measuring transducer that measures a value;
a channel sensor electrically coupled to the measuring transducer, wherein the channel sensor includes a probe that detects the value and relays information in connection with the value to the measuring transducer; and
a detachable fastening device disposed between the measuring transducer and the channel sensor that detachably fastens the measuring transducer to the channel sensor.

13. The device as recited in claim 12, wherein the fastening device is at least one of: a formfitting connection, a form-complementary connection and a catch connection.

14. The device as recited in claim 12, wherein the fastening device includes a first part and a second part, wherein the first part is disposed on the channel sensor and the second part is disposed on the measuring transducer, and wherein the second part is securable on the first part.

15. The device as recited in claim 14, wherein the second part has a U-shaped design having an internal peripheral undercut, the U-shaped second part widening toward an open end of the U-shaped part.

16. The device as recited in claim 12, wherein the channel sensor is coupled to the measuring transducer via a cable, and wherein the cable is disposed at the first end of the channel sensor.

17. The device as recited in claim 16, wherein the cable is guided at an angle of approximately 90° through at least a part of the fastening device situated on the first end of the channel sensor.

18. The device as recited in claim 12, wherein the measuring transducer is at least one of: a humidity measuring transducer and a temperature measuring transducer, and the channel sensor is at least one of: a humidity channel sensor and a temperature channel sensor.

19. The device as recited in claim 12, further comprising:
a digital interface situated between the measuring transducer and the channel sensor.

20. A device for detecting a measured value, comprising:
a measuring transducer that measures at least one of: humidity and temperature;
a channel sensor electrically coupled to the measuring transducer via a cable, wherein the channel sensor includes a probe that detects the at least one of humidity and temperature and relays information in connection with the at least one of humidity and temperature to the measuring transducer via the cable; and
a detachable fastening device disposed between the measuring transducer and the channel sensor that detachably fastens the measuring transducer to the channel sensor, wherein the fastening device includes a first part and a second part, wherein the first part is disposed on the channel sensor and the second part is disposed on the measuring transducer, wherein the second part is securable on the first part, wherein the second part of the fastening device is disposed on a rear wall of the measuring transducer, and wherein a first part of the fastening device is disposed at a first end of the channel sensor.
